(19) United States
(12) Patent Application Publication
(10) Pub. No.: US 2009/0259754 A1
(43) Pub. Date: Oct. 15, 2009

(54) METHOD FOR IP CAMERAS CONNECTION

(76) Inventor: Jen-Fu Wu, Jhubei City (TW)

Correspondence Address: Anthony R. Barkume, 20 Gateway Lane, Manorville, NY, 11949, US

(21) Appl. No.: 12/330,612

(22) Filed: Dec. 9, 2008

(30) Foreign Application Priority Data
Apr. 9, 2008 (CN) 200810146576.3

(51) Int. Cl. G06F 15/16

(52) U.S. Cl. 709/227

(57) ABSTRACT

The present invention relates to a method for IP Cameras connection, which comprises the following steps: registering a presetting identification code of a IP Camera and an IP address onto a global service system server; transferring one identification code to the global service system server by one user device; making the global service system server check the identification code with the presetting identification code; based on the checking result, transferring the IP address to the user device by the global service system server; if the IP Camera is connected to one IP Sharing device, then the user device is able to communicate information with the IP Camera through the global service system server, to get the actual IP address and port number of the user device for connecting with the IP Camera.

### FIELD OF THE INVENTION

The present invention relates to a method for IP Cameras connection, especially for the IP Camera connecting solution by means of identification codes and passwords.

### BACKGROUND OF THE INVENTION

FIG. 1 shows the connecting diagram of the traditional IP Cameras by means of IP address directly, which comprises user device 11, internet 12, IP Camera 13, and messages 14˜15. As shown in FIG. 1, the traditional IP Cameras are connected by means of IP address. If user device 11 wants to get the captured video content from IP Camera 13, user device 11 will put the IP address of the IP Camera 13 into the request package in order to connect the IP Camera 13 through Internet 12. After the IP Camera 13 receives the request of message 14, it will be able to transfer the captured video image information 15 to the user device 11. Therefore, the IP Camera 13 must use the means of fixed IP address only, once the IP Camera 13 moves to other network domain, user device 11 will not be able to connect with camera 13 by means of the same IP address.

FIG. 2 shows the connecting diagram of the traditional IP Cameras by means of dynamic IP address, which comprises user device 21, Internet 22, IP Camera 23, dynamic domain name server 24 (DDNS Server), and the IP Sharing device 241, 242. For solving the problem of the network structure in the FIG. 1, the solution uses dynamic domain name server (DDNS) for the connection. As shown in FIG. 2, user device 21 transfers information request by means of network domain name, when user device transmits information request, it will transfer the information with network domain name of the IP Camera 23 to the dynamic domain name server 24 through the IP Sharing device 242. Once the dynamic domain name server 24 receives the information with network domain name, it will check the table for getting the IP address respective to the network domain name, and transfers back the IP address information to the user device 21 through IP Sharing device 241. Therefore, the user device is able to use the replied IP address to transmit the information request to the IP Camera 23. When the IP Camera 23 uses dynamic IP address or moves to the other network domain, the respective network domain name and the IP address information of the dynamic network domain name server 24 need to be updated. Although the solution is able to solve the problem of IP Camera 23 using dynamic IP address and network domain movement efficiently, the user needs to modify the setting values of IP Sharing device 241, 242 when setting the IP Camera 23, and tries to understand how to apply and modify the complex settings of the port mapping information, this is not suitable for common users without well computer knowledge.

FIG. 3 shows the connecting diagram of the traditional IP Cameras by proxy server, which comprises user device 31, Internet 32, IP Camera 33, proxy server 34, and information 35˜38. As shown in FIG. 3, when user device 31 wants to get the captured video image of IP Camera 33, it will transmit information 35 to proxy server 34, and proxy server 34 will transmit information request 36 to IP Camera 33 after receiving information 35. After receiving information request 36, IP Camera 33 will transmit information 37 comprising captured video image to proxy server 34, and proxy server 34 will forward the information back to user device 31. Therefore, IP Camera 33 is able to use any IP address in any network domain without any constrain, and the solution is very easy to be managed through proxy server 34. But there is a disadvantage, all the information data have to be transmitted through proxy server 34, if many IP Cameras transfer video data simultaneously, the loading of proxy server 34 will be very heavy and the bandwidth will be jammed. Furthermore, if proxy server 34 is broken, all the system cannot work any more.

There are several disadvantages in the traditional technology:
1. By the traditional IP Cameras connecting solution using IP address directly, IP Cameras can use fixed IP address only, which increase the difficulty of moving IP Cameras.
2. By the traditional IP Cameras connecting solution using dynamic network domain name server, users need to understand how to setup and modify the port mapping information in complex IP Sharing device, it is not easy to common users without well network knowledge.
3. By the traditional IP Cameras connecting solution using proxy server, all the information data need to be transferred through proxy server, which increases the heavy loading and bandwidth issues of proxy server.

Therefore, how to improve above disadvantages of traditional solutions to make IP Cameras be easily used by common users without any location, IP address, and unique proxy server constrain, is the major topic of the present invention.

### SUMMARY OF THE INVENTION

An objective of the present invention is to provide a new and advanced IP Camera connection solution, which makes users use identification numbers and passwords to connect with IP Cameras directly, without any constrain of IP Camera setup location and IP address, to avoid the setup difficulty and heavy loading and bandwidth issues of single proxy server.

According to the present invention, a method for IP Cameras connection, comprising steps of:

registering a presetting identification code of a IP Camera and an IP address onto a global service system server;

transferring an identification code to the global service system server by a user device;

making the global service system server check the identification code with the presetting identification code;

based on the checking result, transferring the IP address to the user device by the global service system server; if the IP Camera is connected to an IP Sharing device, then the user device is able to communicate information with the IP Camera through the global service system server, to get the actual IP address of the IP Camera for connecting with the IP Camera.

In accordance with one aspect of the present invention, the presetting identification code comprises a presetting identification number and a presetting password.

In accordance with one aspect of the present invention, the identification code comprises an identification number and a password.

In accordance with one aspect of the present invention, the user device is a computer.

In accordance with one aspect of the present invention, wherein the user device is a 3G mobile phone set.

In accordance with one aspect of the present invention, the user device is a PDA (Personal Digital Assistant).

In accordance with one aspect of the present invention, the user device connects with the IP Camera through Internet.

In accordance with one aspect of the present invention, the user device transfers the identification code to the global service system server through Internet.

In accordance with one aspect of the present invention, the global service system server comprises a main server and a secondary server and the secondary server is able to replace with the main server once the main server is down.

According to the present invention, a method for IP Cameras connection comprising steps of:

using a user device to transfer an identification code to a global service system server;

making the global service system server transmit the identification code to a corresponding IP Camera for checking the correction of the identification code;

based on the checking result, using the global service system server to transfer an IP address to the user device;

making the user device connect with the IP Camera by the IP address.

The present invention may best be understood through the following description with reference to the accompanying drawings wherein:

### BRIEF DESCRIPTION OF THE DRAWINGS

FIG. 1 shows the connecting diagram of the traditional IP Cameras by means of IP address directly;

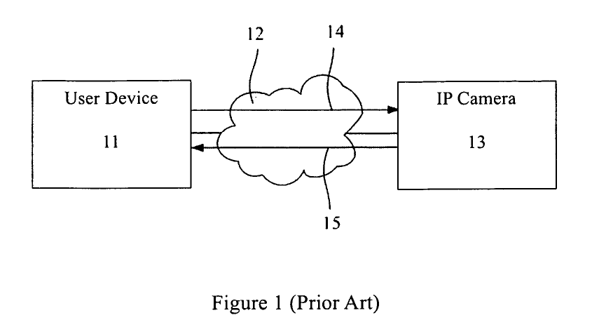

FIG. 2 shows the connecting diagram of the traditional IP Cameras by means of dynamic IP address;

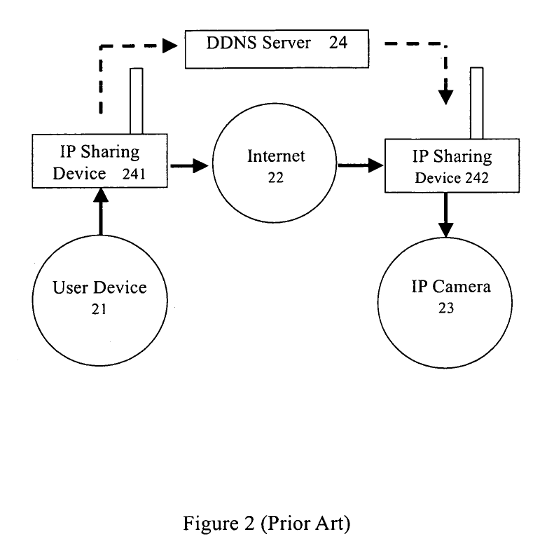

FIG. 3 shows the connecting diagram of the traditional IP Cameras by proxy server;

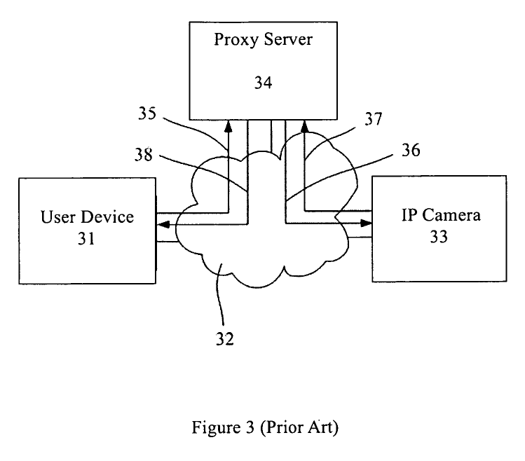

FIG. 4 shows the flow chart according to the present invention of IP Camera connection solution;

FIG. 5 shows the block diagram according to the present invention of IP Camera connection solution;

FIG. 6 shows the application block diagram according to the present invention of IP Camera connection solution.

### DETAILED DESCRIPTION OF THE INVENTION

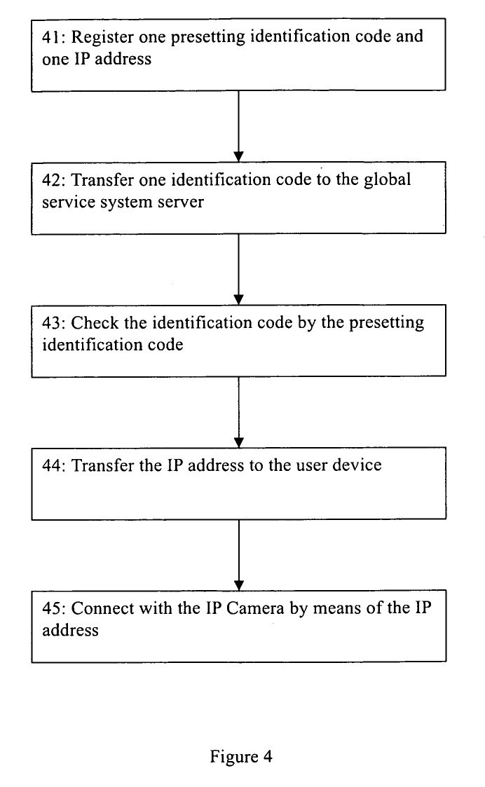

FIG. 4 shows the flow chart according to the present invention of IP Camera connection solution, which comprises the following steps:

Step 41: registering one presetting identification code and one IP address of one IP Camera into one global service system server;

Step 42: using one user device to transfer one identification code to the global service system server;

Step 43: making the global service system server check the identification code by the presetting identification code;

Step 44: based on the checking result, using the global service system server transfer the IP address to the user device;

Step 45: making the user device connect with the IP Camera by means of the IP address.

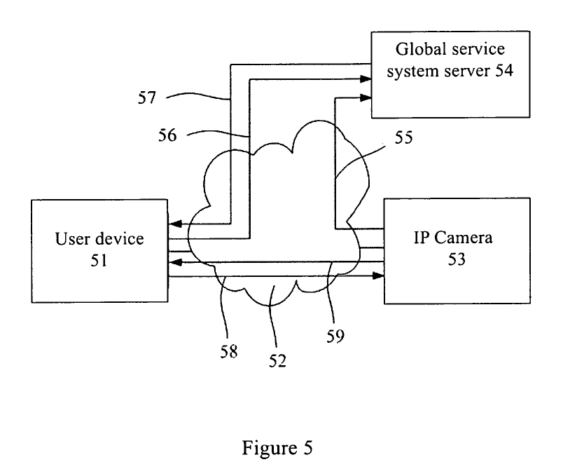

FIG. 5 shows the block diagram according to the present invention of IP Camera connection solution, wherein comprises user device 51, Internet 52, IP Camera 53, global service system server 54, and information 55˜59.

According to the present invention of IP Camera connection solution, in step 41, IP Camera 53 will register its own information such as presetting identification code and IP address (as shown in information 55) into the global service system server 54 through Internet 52 wherein the presetting identification code comprises one presetting identification number and one presetting password. Secondly, if end user wants to watch the captured video image by IP Camera 53, he is able to enter identification code by the interface that is provided by the user device 51 in the step 42 wherein the identification code comprises identification number and password, and the user device 51 will transfer these information to global service system server 54 (as shown in information 56). After the global service system server 54 receiving the identification code, it will check the user entered identification code with the presetting identification code registered in the IP Camera 53 in step 43, if the checking result is correct, global service system server 54 will check the IP address of the IP Camera 53 by the presetting identification code, and transfers corresponding IP address to the user device 51 in step 44 (as shown in information 57). Once the user device 51 knows the IP address of IP Camera 53, it is able to connect with IP Camera 53 in the step 45, and transmits information request to IP Camera 53 (as shown in information 58), in order to get the captured video image by IP Camera 53 (as shown in information 59). In which, the global service system server comprises one main server and one or multiple secondary servers, once the main server is down, the secondary server is able to backup the main server for maintaining the operation. The global service system server can also use a distributed architecture integrated by multiple servers to share the system loading.

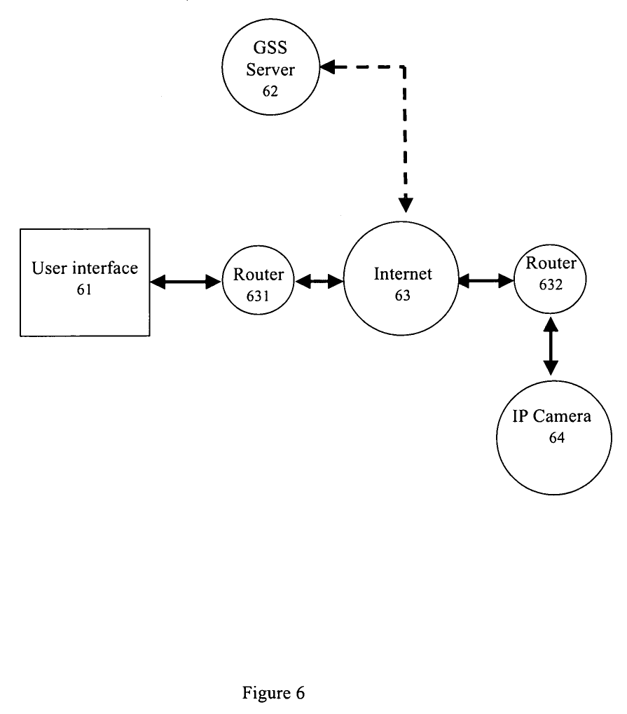

FIG. 6 shows the block diagram according to the present invention of IP Camera connection solution, wherein comprises one user interface 61 (including one IE browser interface, one PC application operating interface, and one 3G mobile interface), one global service system server 62 (GSS Server), two routers 631, 632, one Internet 63, and one IP Camera 64 (IP Camera).

According to the present invention of IP Camera connection solution, user does not need to know the IP address of IP Camera 64, he only needs to use user interface 61 to log in the camera ID code and password of the IP Camera 64 to connect with IP Camera 64. In which, the camera ID code and password are able to be decoded by global service system server 62 (GSS Server) to get the actual IP address of IP Camera 64, and connect with IP Camera 64 directly through user interface 61; and the user device is one of IE browser, PC application interface, and 3G mobile, and connect with internet 63 by the respective interface through the router 631, to connect with IP Camera 64 through router 632 or IP Sharing device. Therefore, by the present invention, we can simplify the installation procedures and operation steps, and achieve the global vision after integrated with several video connection solutions (IE browser, PC application software, and 3G mobile software).

There are several advantages of the present invention:

1. According to the present invention of IP Camera connection solution, users do not need to have any network knowledge because all the connections are created by the identification codes and passwords.

2. According to the present invention of IP Camera connection solution, the global service system server takes the responsibility of mapping and transferring of identification code and IP address only, does not need to transfer the captured video image by the IP Camera, so, there is no bandwidth issues or over loading problem.

3. According to the present invention of IP Camera connection solution, IP Camera is able to be setup at any place without the constrain of IP address, IP Camera only needs to send out one massage to update the register information on the global service system server.

To sum up, according to the present invention, the end user is able to connect with IP Camera by only identification number and password, is a very advanced and useful solution. For any design modification, such as using more complex certification methods, using more IP Cameras, or using more global service system servers, are all protected and covered by the present invention if the solution uses one server to transfer the identification code and the respective IP address of the IP Camera for IP Camera connection.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims to be accorded with the broadest interpretation so as to encompass all such modifications and similar solutions.

What is claimed is:

1. A method for IP Cameras connection, comprising steps of:
registering a presetting identification code of a IP Camera and an IP address onto a global service system server;
transferring an identification code to the global service system server by a user device;
making the global service system server check the identification code with the presetting identification code;
based on the checking result, transferring the IP address to the user device by the global service system server; if the IP Camera is connected to an IP Sharing device, then the user device being able to communicate information with the IP Camera through the global service system server, to get the actual IP address and port number of the user device for connecting with the IP Camera.

2. A method according to claim 1 wherein the presetting identification code comprises a presetting identification number and a presetting password.

3. A method according to claim 1 wherein the identification code comprises an identification number and a password; the identification number is a nine digit number or any length of digit number or alphabetic string.

4. A method according to claim 1 wherein the user device is a computer.

5. A method according to claim 1 wherein the user device is a 3G mobile phone set.

6. A method according to claim 1 wherein the user device is a PDA (Personal Digital Assistant).

7. A method according to claim 1 wherein the user device connects with the IP Camera through Internet.

8. A method according to claim 1 wherein the user device transfers the identification code to the global service system server through Internet.

9. A method according to claim 1 wherein the global service system server comprises a main server and a secondary server and the secondary server is able to replace with the main server once the main server is down.

10. A method for IP Cameras connection comprising steps of:
using a user device to transfer an identification code to a global service system server;
making the global service system server transmit the identification code to a corresponding IP Camera for checking the correction of the identification code;
based on the checking result, using the global service system server to transfer an IP address to the user device;
making the user device connect with the IP Camera by the IP address.
